(19) United States
(12) Patent Application Publication
(10) Pub. No.: US 2021/0117487 A1
(43) Pub. Date: Apr. 22, 2021

(54) CONDITIONAL FILTERS WITH APPLICATIONS TO JOIN PROCESSING

(71) Applicant: Tableau Software, LLC, Seattle, WA (US)

(72) Inventors: Richard Lee Cole, Los Gatos, CA (US); Daniel Shaw Ting, Seattle, WA (US)

(21) Appl. No.: 17/076,735

(22) Filed: Oct. 21, 2020

Related U.S. Application Data
(60) Provisional application No. 62/924,622, filed on Oct. 22, 2019.

(51) Int. Cl. G06F 16/9532; G06F 16/9538

(52) U.S. Cl. CPC G06F 16/9532; G06F 16/9538

(57) ABSTRACT

Embodiments are directed to data processing. A plurality of fact objects and a plurality of attribute objects may be provided such that each of the attribute objects may be associated with one or more fact objects. A fact key may be generated for each of the plurality of fact objects based on information associated with each fact object. Attribute objects associated with each of the plurality of fact objects may be determined based on attribute information associated with each fact object. An attribute key for each of the one or more attribute objects may be generated based on the attribute information. The attribute keys and a plurality of fact keys may be stored at a plurality of storage locations in a data catalog such that each storage location corresponds to one of the plurality of fact keys.

### CROSS-REFERENCE TO RELATED APPLICATION

This application is a Utility Patent application based on previously filed U.S. Provisional Patent Application No. 62/924,622 filed on Oct. 22, 2019, the benefit of the filing date of which is hereby claimed under 35 U.S.C. § 119(e) and which is further incorporated in entirety by reference.

### TECHNICAL FIELD

The present invention relates generally to data processing, and more particularly, but not exclusively to, improving the performance of set membership testing.

### BACKGROUND

Bloom filters, cuckoo filters, and other approximate set membership sketches have a range of applications, including a number in database systems and networking. Oftentimes, expensive operations need to be executed only if an item is in a data set. These filters may provide an inexpensive, memory efficient way to test if an item is in a set and avoid unnecessary operations. However, existing data sketches may be limited to allowing membership testing for single set. However, in database join processing, the relevant set is not fixed and may be determined by a set of predicates. Using existing methods, predicate specific filters must be built at query time and require scanning an input table. Thus, it is with respect to these considerations and others that the present invention has been made.

### BRIEF DESCRIPTION OF THE DRAWINGS

Non-limiting and non-exhaustive embodiments of the present innovations are described with reference to the following drawings. In the drawings, like reference numerals refer to like parts throughout the various figures unless otherwise specified. For a better understanding of the described innovations, reference will be made to the following Detailed Description of Various Embodiments, which is to be read in association with the accompanying drawings, wherein:

FIG. 1 illustrates a system environment in which various embodiments may be implemented;

FIG. 2 illustrates a schematic embodiment of a client computer;

FIG. 3 illustrates a schematic embodiment of a network computer;

FIG. 4 illustrates a logical architecture of a system for conditional filters with applications to join processing in accordance with one or more of the various embodiments;

FIG. 5 illustrates a logical schematic of a portion of a system for conditional filters with applications to join processing in accordance with one or more of the various embodiments;

FIG. 6A illustrates a logical schematic showing a portion of a data processing system for generating data catalogs for conditional filters with applications to join processing in accordance with one or more of the various embodiments;

FIG. 6B illustrates a logical schematics of a data catalog for conditional filters with applications to join processing in accordance with one or more of the various embodiments;

FIG. 7 illustrates an overview flowchart for a process for conditional filters with applications to join processing in accordance with one or more of the various embodiments;

FIG. 8 illustrates a flowchart for a process for processing a fact object for conditional filters with applications to join processing in accordance with one or more of the various embodiments;

FIG. 9 illustrates a flowchart for a process for inserting a fact information into a data catalog in accordance with one or more of the various embodiments; and

FIG. 10 illustrates a flowchart for a process for responding to queries using data catalogs in accordance with one or more of the various embodiments.

### DETAILED DESCRIPTION OF VARIOUS EMBODIMENTS

Various embodiments now will be described more fully hereinafter with reference to the accompanying drawings, which form a part hereof, and which show, by way of illustration, specific exemplary embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media or devices. Accordingly, the various embodiments may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example, in some embodiments, the following terms are also used herein according to the corresponding meaning, unless the context clearly dictates otherwise.

As used herein the term, “engine” refers to logic embodied in hardware or software instructions, which can be written in a programming language, such as C, C++, Objective-C, COBOL, Java™, PHP, Perl, JavaScript, Ruby, VBScript, Microsoft .NET™ languages such as C#, or the like. An engine may be compiled into executable programs or written in interpreted programming languages. Software engines may be callable from other engines or from themselves. Engines described herein refer to one or more logical modules that can be merged with other engines or applications, or can be divided into sub-engines. The engines can be stored in non-transitory computer-readable medium or computer storage device and be stored on and executed by one or more general purpose computers, thus creating a special purpose computer configured to provide the engine.

As used herein, the term “data source” refers to databases, applications, services, file systems, or the like, that store or provide information for an organization. Examples of data sources may include, RDBMS databases, graph databases, spreadsheets, file systems, document management systems, local or remote data streams, or the like. In some cases, data sources are organized around one or more tables or table-like structure. In other cases, data sources be organized as a graph or graph-like structure.

As used herein the term “data object” refers to one or more data structures that comprise data models. In some cases, data objects may be considered portions of the data model. Data objects may represent individual instances of items or classes or kinds of items.

As used herein the term “configuration information” refers to information that may include rule based policies, pattern matching, scripts (e.g., computer readable instructions), or the like, that may be provided from various sources, including, configuration files, databases, user input, built-in defaults, or the like, or combination thereof.

The following briefly describes embodiments of the invention to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed to data processing using one or more processors that execute one or more instructions to perform as described herein. In one or more of the various embodiments, a plurality of fact objects and a plurality of attribute objects may be provided such that each of the attribute objects may be associated with one or more fact objects.

In one or more of the various embodiments, a fact key may be generated for each of the plurality of fact objects based on information associated with each fact object.

In one or more of the various embodiments, one or more attribute objects associated with each of the plurality of fact objects may be determined based on attribute information associated with each fact object.

In one or more of the various embodiments, an attribute key for each of the one or more attribute objects may be generated based on the attribute information.

In one or more of the various embodiments, the one or more attribute keys and a plurality of fact keys may be stored at a plurality of storage locations in a data catalog such that each storage location corresponds to one of the plurality of fact keys.

In one or more of the various embodiments, in response to a query that includes a query fact object and one or more query attribute objects, further actions may be performed, including: generating a query fact key based on the query fact object; generating one or more query attribute keys based on the one or more query attribute objects; and providing a query result based on a comparison of the one or more query attribute keys and one or more attribute keys associated with another fact key in the data catalog having an equivalent value to the query fact key such that the query result is affirmative when the one or more query attribute keys match the one or more attribute keys associated with the other fact key.

In one or more of the various embodiments, an alternate fact key may be generated for each of the plurality of fact objects based on information associated with each fact object. And, in one or more of the various embodiments, in response to a location in the data catalog corresponding to the fact key being unavailable, storing the one or more attribute keys and the alternate fact key for each fact object at a storage location in the data catalog such that the storage location corresponds to the alternate fact key.

In one or more of the various embodiments, an attribute vector for a fact object stored at a storage location in the data catalog may be generated based on a number of the one or more attribute objects associated with the fact object; the one or more attribute keys may be stored in the attribute vector; and the attribute vector may be stored at the storage location.

In one or more of the various embodiments, a Bloom filter may be generated for one or more fact objects based on the one or more attribute keys; the Bloom filter may be stored at each storage location in the data catalog associated with the one or more fact objects; and the Bloom filter may be employed to determine if the query attribute keys have equivalent values to the one or more attribute keys associated with the other fact key.

In one or more of the various embodiments, the data catalog may be generated based on a cuckoo filter such that each cuckoo filter key is a fact key or an alternate fact key associated with a fact object.

### Illustrated Operating Environment

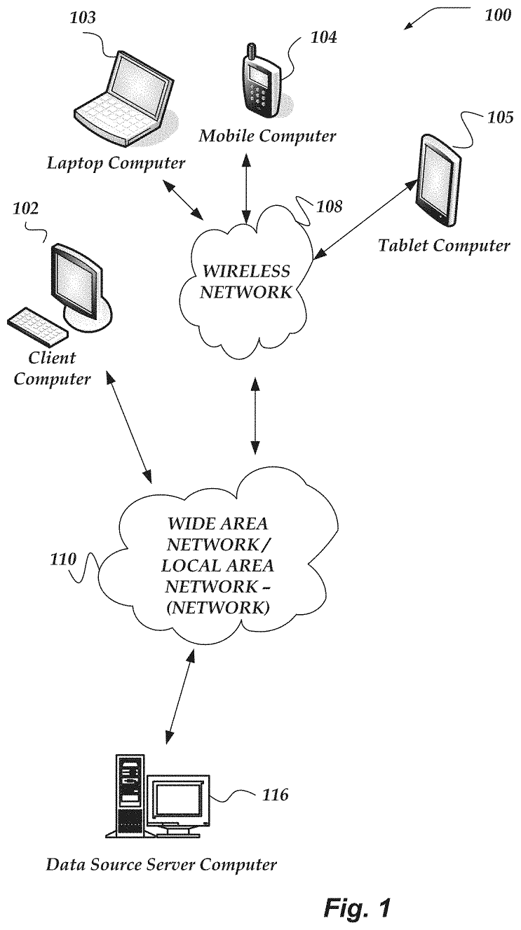

FIG. 1 shows components of one embodiment of an environment in which embodiments of the invention may be practiced. Not all of the components may be required to practice the invention, and variations in the arrangement and type of the components may be made without departing from the spirit or scope of the invention. As shown, system 100 of FIG. 1 includes local area networks (LANs)/wide area networks (WANs)—(network) 110, wireless network 108, client computers 102-105, data source server computer 116, or the like.

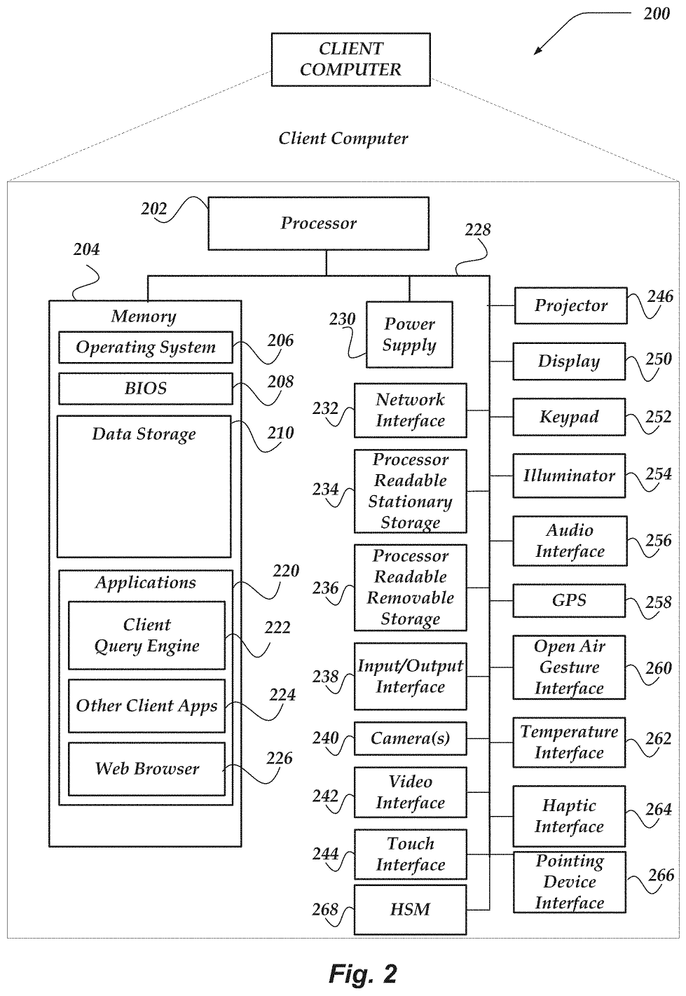

At least one embodiment of client computers 102-105 is described in more detail below in conjunction with FIG. 2. In one embodiment, at least some of client computers 102-105 may operate over one or more wired or wireless networks, such as networks 108, or 110. Generally, client computers 102-105 may include virtually any computer capable of communicating over a network to send and receive information, perform various online activities, offline actions, or the like. In one embodiment, one or more of client computers 102-105 may be configured to operate within a business or other entity to perform a variety of services for the business or other entity. For example, client computers 102-105 may be configured to operate as a web server, firewall, client application, media player, mobile telephone, game console, desktop computer, or the like. However, client computers 102-105 are not constrained to these services and may also be employed, for example, as for end-user computing in other embodiments. It should be recognized that more or less client computers (as shown in FIG. 1) may be included within a system such as described herein, and embodiments are therefore not constrained by the number or type of client computers employed.

Computers that may operate as client computer 102 may include computers that typically connect using a wired or wireless communications medium such as personal computers, multiprocessor systems, microprocessor-based or programmable electronic devices, network PCs, or the like. In some embodiments, client computers 102-105 may include virtually any portable computer capable of connecting to another computer and receiving information such as, laptop computer 103, mobile computer 104, tablet computers 105, or the like. However, portable computers are not so limited and may also include other portable computers such as cellular telephones, display pagers, radio frequency (RF) devices, infrared (IR) devices, Personal Digital Assistants (PDAs), handheld computers, wearable computers, integrated devices combining one or more of the preceding computers, or the like. As such, client computers 102-105 typically range widely in terms of capabilities and features. Moreover, client computers 102-105 may access various computing applications, including a browser, or other web-based application.

A web-enabled client computer may include a browser application that is configured to send requests and receive responses over the web. The browser application may be configured to receive and display graphics, text, multimedia, and the like, employing virtually any web-based language. In one embodiment, the browser application is enabled to employ JavaScript, HyperText Markup Language (HTML), eXtensible Markup Language (XML), JavaScript Object Notation (JSON), Cascading Style Sheets (CSS), or the like, or combination thereof, to display and send a message. In one embodiment, a user of the client computer may employ the browser application to perform various activities over a network (online). However, another application may also be used to perform various online activities.

Client computers 102-105 also may include at least one other client application that is configured to receive or send content between another computer. The client application may include a capability to send or receive content, or the like. The client application may further provide information that identifies itself, including a type, capability, name, and the like. In one embodiment, client computers 102-105 may uniquely identify themselves through any of a variety of mechanisms, including an Internet Protocol (IP) address, a phone number, Mobile Identification Number (MIN), an electronic serial number (ESN), a client certificate, or other device identifier. Such information may be provided in one or more network packets, or the like, sent between other client computers, visualization server computer 116, or other computers.

Client computers 102-105 may further be configured to include a client application that enables an end-user to log into an end-user account that may be managed by another computer, such as data source server computer 116, or the like. Such an end-user account, in one non-limiting example, may be configured to enable the end-user to manage one or more online activities, including in one non-limiting example, project management, software development, system administration, configuration management, search activities, social networking activities, browse various websites, communicate with other users, or the like. Also, client computers may be arranged to enable users to display reports, interactive user-interfaces, or results provided by visualization server computer 116.

Wireless network 108 is configured to couple client computers 103-105 and its components with network 110. Wireless network 108 may include any of a variety of wireless sub-networks that may further overlay stand-alone ad-hoc networks, and the like, to provide an infrastructure-oriented connection for client computers 103-105. Such sub-networks may include mesh networks, Wireless LAN (WLAN) networks, cellular networks, and the like. In one embodiment, the system may include more than one wireless network.

Wireless network 108 may further include an autonomous system of terminals, gateways, routers, and the like connected by wireless radio links, and the like. These connectors may be configured to move freely and randomly and organize themselves arbitrarily, such that the topology of wireless network 108 may change rapidly.

Wireless network 108 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile computers, such as client computers 103-105 with various degrees of mobility. In one non-limiting example, wireless network 108 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 108 may include virtually any wireless communication mechanism by which information may travel between client computers 103-105 and another computer, network, a cloud-based network, a cloud instance, or the like.

Network 110 is configured to couple network computers with other computers, including, data source server computer 116, client computers 102, and client computers 103-105 through wireless network 108, or the like. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, Ethernet port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 may be configured to transport information of an Internet Protocol (IP).

Additionally, communication media typically embodies computer readable instructions, data structures, program modules, or other transport mechanism and includes any information non-transitory delivery media or transitory delivery media. By way of example, communication media includes wired media such as twisted pair, coaxial cable, fiber optics, wave guides, and other wired media and wireless media such as acoustic, RF, infrared, and other wireless media.

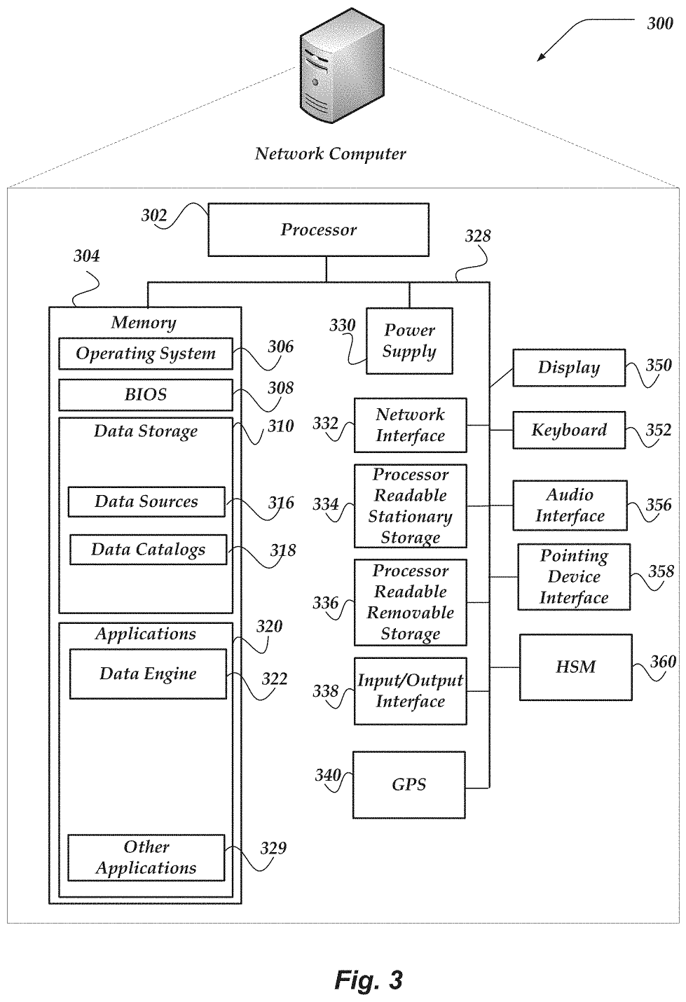

Also, one embodiment of data source server computer 116 is described in more detail below in conjunction with FIG. 3. Although FIG. 1 illustrates data source server computer 116, or the like, as a single computer, the innovations or embodiments are not so limited. For example, one or more functions of data source server computer 116, or the like, may be distributed across one or more distinct network computers. Moreover, in one or more embodiments, data source server computer 116 may be implemented using a plurality of network computers. Further, in one or more of the various embodiments, data source server computer 116, or the like, may be implemented using one or more cloud instances in one or more cloud networks. Accordingly, these innovations and embodiments are not to be construed as being limited to a single environment, and other configurations, and other architectures are also envisaged.

### Illustrative Client Computer

FIG. 2 shows one embodiment of client computer 200 that may include many more or less components than those shown. Client computer 200 may represent, for example, one or more embodiment of mobile computers or client computers shown in FIG. 1.

Client computer 200 may include processor 202 in communication with memory 204 via bus 228. Client computer 200 may also include power supply 230, network interface 232, audio interface 256, display 250, keypad 252, illuminator 254, video interface 242, input/output interface 238, haptic interface 264, global positioning systems (GPS) receiver 258, open air gesture interface 260, temperature interface 262, camera(s) 240, projector 246, pointing device interface 266, processor-readable stationary storage device 234, and processor-readable removable storage device 236. Client computer 200 may optionally communicate with a base station (not shown), or directly with another computer. And in one embodiment, although not shown, a gyroscope may be employed within client computer 200 to measuring or maintaining an orientation of client computer 200.

Power supply 230 may provide power to client computer 200. A rechargeable or non-rechargeable battery may be used to provide power. The power may also be provided by an external power source, such as an AC adapter or a powered docking cradle that supplements or recharges the battery.

Network interface 232 includes circuitry for coupling client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 232 is sometimes known as a transceiver, transceiving device, or network interface card (MC).

Audio interface 256 may be arranged to produce and receive audio signals such as the sound of a human voice. For example, audio interface 256 may be coupled to a speaker and microphone (not shown) to enable telecommunication with others or generate an audio acknowledgment for some action. A microphone in audio interface 256 can also be used for input to or control of client computer 200, e.g., using voice recognition, detecting touch based on sound, and the like.

Display 250 may be a liquid crystal display (LCD), gas plasma, electronic ink, light emitting diode (LED), Organic LED (OLED) or any other type of light reflective or light transmissive display that can be used with a computer. Display 250 may also include a touch interface 244 arranged to receive input from an object such as a stylus or a digit from a human hand, and may use resistive, capacitive, surface acoustic wave (SAW), infrared, radar, or other technologies to sense touch or gestures.

Projector 246 may be a remote handheld projector or an integrated projector that is capable of projecting an image on a remote wall or any other reflective object such as a remote screen.

Video interface 242 may be arranged to capture video images, such as a still photo, a video segment, an infrared video, or the like. For example, video interface 242 may be coupled to a digital video camera, a web-camera, or the like. Video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 252 may comprise any input device arranged to receive input from a user. For example, keypad 252 may include a push button numeric dial, or a keyboard. Keypad 252 may also include command buttons that are associated with selecting and sending images.

Illuminator 254 may provide a status indication or provide light. Illuminator 254 may remain active for specific periods of time or in response to event messages. For example, when illuminator 254 is active, it may back-light the buttons on keypad 252 and stay on while the client computer is powered. Also, illuminator 254 may back-light these buttons in various patterns when particular actions are performed, such as dialing another client computer. Illuminator 254 may also cause light sources positioned within a transparent or translucent case of the client computer to illuminate in response to actions.

Further, client computer 200 may also comprise hardware security module (HSM) 268 for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, HSM 268 may be a stand-alone computer, in other cases, HSM 268 may be arranged as a hardware card that may be added to a client computer.

Client computer 200 may also comprise input/output interface 238 for communicating with external peripheral devices or other computers such as other client computers and network computers. The peripheral devices may include an audio headset, virtual reality headsets, display screen glasses, remote speaker system, remote speaker and microphone system, and the like. Input/output interface 238 can utilize one or more technologies, such as Universal Serial Bus (USB), Infrared, WiFi, WiMax, Bluetooth™, and the like.

Input/output interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to client computer 200.

Haptic interface 264 may be arranged to provide tactile feedback to a user of the client computer. For example, the haptic interface 264 may be employed to vibrate client computer 200 in a particular way when another user of a computer is calling. Temperature interface 262 may be used to provide a temperature measurement input or a temperature changing output to a user of client computer 200. Open air gesture interface 260 may sense physical gestures of a user of client computer 200, for example, by using single or stereo video cameras, radar, a gyroscopic sensor inside a computer held or worn by the user, or the like. Camera 240 may be used to track physical eye movements of a user of client computer 200.

GPS transceiver 258 can determine the physical coordinates of client computer 200 on the surface of the Earth, which typically outputs a location as latitude and longitude values. GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client computer 200 on the surface of the Earth. It is understood that under different conditions, GPS transceiver 258 can determine a physical location for client computer 200. In one or more embodiments, however, client computer 200 may, through other components, provide other information that may be employed to determine a physical location of the client computer, including for example, a Media Access Control (MAC) address, IP address, and the like.

In at least one of the various embodiments, applications, such as, operating system 206, client query engine 222, other client apps 224, web browser 226, or the like, may be arranged to employ geo-location information to select one or more localization features, such as, time zones, languages, currencies, calendar formatting, or the like. Localization features may be used in display objects, data models, data objects, user-interfaces, reports, as well as internal processes or databases. In at least one of the various embodiments, geo-location information used for selecting localization information may be provided by GPS 258. Also, in some embodiments, geolocation information may include information provided using one or more geolocation protocols over the networks, such as, wireless network 108 or network 111.

Human interface components can be peripheral devices that are physically separate from client computer 200, allowing for remote input or output to client computer 200. For example, information routed as described here through human interface components such as display 250 or keyboard 252 can instead be routed through network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include web browser application 226 that is configured to receive and to send web pages, web-based messages, graphics, text, multimedia, and the like. The client computer's browser application may employ virtually any programming language, including a wireless application protocol messages (WAP), and the like. In one or more embodiments, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

Memory 204 may include RAM, ROM, or other types of memory. Memory 204 illustrates an example of computer-readable storage media (devices) for storage of information such as computer-readable instructions, data structures, program modules or other data. Memory 204 may store BIOS 208 for controlling low-level operation of client computer 200. The memory may also store operating system 206 for controlling the operation of client computer 200. It will be appreciated that this component may include a general-purpose operating system such as a version of UNIX, or LINUX™, or a specialized client computer communication operating system such as Windows Phone™, or the Symbian® operating system. The operating system may include, or interface with a Java virtual machine module that enables control of hardware components or operating system operations via Java application programs.

Memory 204 may further include one or more data storage 210, which can be utilized by client computer 200 to store, among other things, applications 220 or other data. For example, data storage 210 may also be employed to store information that describes various capabilities of client computer 200. The information may then be provided to another device or computer based on any of a variety of methods, including being sent as part of a header during a communication, sent upon request, or the like. Data storage 210 may also be employed to store social networking information including address books, buddy lists, aliases, user profile information, or the like. Data storage 210 may further include program code, data, algorithms, and the like, for use by a processor, such as processor 202 to execute and perform actions. In one embodiment, at least some of data storage 210 might also be stored on another component of client computer 200, including, but not limited to, non-transitory processor-readable removable storage device 236, processor-readable stationary storage device 234, or even external to the client computer.

Applications 220 may include computer executable instructions which, when executed by client computer 200, transmit, receive, or otherwise process instructions and data. Applications 220 may include, for example, client query engine 222, other client applications 224, web browser 226, or the like. Client computers may be arranged to exchange communications one or more servers.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, visualization applications, and so forth.

Additionally, in one or more embodiments (not shown in the figures), client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), client computer 200 may include one or more hardware micro-controllers instead of CPUs. In one or more embodiments, the one or more micro-controllers may directly execute their own embedded logic to perform actions and access its own internal memory and its own external Input and Output Interfaces (e.g., hardware pins or wireless transceivers) to perform actions, such as System On a Chip (SOC), or the like.

### Illustrative Network Computer

FIG. 3 shows one embodiment of network computer 300 that may be included in a system implementing one or more of the various embodiments. Network computer 300 may include many more or less components than those shown in FIG. 3. However, the components shown are sufficient to disclose an illustrative embodiment for practicing these innovations. Network computer 300 may represent, for example, one embodiment of data source server computer 116, or the like, of FIG. 1.

Network computers, such as, network computer 300 may include a processor 302 that may be in communication with a memory 304 via a bus 328. In some embodiments, processor 302 may be comprised of one or more hardware processors, or one or more processor cores. In some cases, one or more of the one or more processors may be specialized processors designed to perform one or more specialized actions, such as, those described herein. Network computer 300 also includes a power supply 330, network interface 332, audio interface 356, display 350, keyboard 352, input/output interface 338, processor-readable stationary storage device 334, and processor-readable removable storage device 336. Power supply 330 provides power to network computer 300.

Network interface 332 includes circuitry for coupling network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax),

Session Initiation Protocol/Real-time Transport Protocol (SIP/RTP), or any of a variety of other wired and wireless communication protocols. Network interface 332 is sometimes known as a transceiver, transceiving device, or network interface card (NIC). Network computer 300 may optionally communicate with a base station (not shown), or directly with another computer.

Audio interface 356 is arranged to produce and receive audio signals such as the sound of a human voice. For example, audio interface 356 may be coupled to a speaker and microphone (not shown) to enable telecommunication with others or generate an audio acknowledgment for some action. A microphone in audio interface 356 can also be used for input to or control of network computer 300, for example, using voice recognition.

Display 350 may be a liquid crystal display (LCD), gas plasma, electronic ink, light emitting diode (LED), Organic LED (OLED) or any other type of light reflective or light transmissive display that can be used with a computer. In some embodiments, display 350 may be a handheld projector or pico projector capable of projecting an image on a wall or other object.

Network computer 300 may also comprise input/output interface 338 for communicating with external devices or computers not shown in FIG. 3. Input/output interface 338 can utilize one or more wired or wireless communication technologies, such as USB™, Firewire™, WiFi, WiMax, Thunderbolt™, Infrared, Bluetooth™, Zigbee™, serial port, parallel port, and the like.

Also, input/output interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to network computer 300. Human interface components can be physically separate from network computer 300, allowing for remote input or output to network computer 300. For example, information routed as described here through human interface components such as display 350 or keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through pointing device interface 358 to receive user input.

GPS transceiver 340 can determine the physical coordinates of network computer 300 on the surface of the Earth, which typically outputs a location as latitude and longitude values. GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of network computer 300 on the surface of the Earth. It is understood that under different conditions, GPS transceiver 340 can determine a physical location for network computer 300. In one or more embodiments, however, network computer 300 may, through other components, provide other information that may be employed to determine a physical location of the client computer, including for example, a Media Access Control (MAC) address, IP address, and the like.

In at least one of the various embodiments, applications, such as, operating system 306, assessment engine 322, visualization engine 324, modeling engine 326, other applications 329, or the like, may be arranged to employ geo-location information to select one or more localization features, such as, time zones, languages, currencies, currency formatting, calendar formatting, or the like. Localization features may be used in user interfaces, dashboards, visualizations, reports, as well as internal processes or databases. In at least one of the various embodiments, geo-location information used for selecting localization information may be provided by GPS 340. Also, in some embodiments, geolocation information may include information provided using one or more geolocation protocols over the networks, such as, wireless network 108 or network 111.

Memory 304 may include Random Access Memory (RAM), Read-Only Memory (ROM), or other types of memory. Memory 304 illustrates an example of computer-readable storage media (devices) for storage of information such as computer-readable instructions, data structures, program modules or other data. Memory 304 stores a basic input/output system (BIOS) 308 for controlling low-level operation of network computer 300. The memory also stores an operating system 306 for controlling the operation of network computer 300. It will be appreciated that this component may include a general-purpose operating system such as a version of UNIX, or Linux®, or a specialized operating system such as Microsoft Corporation's Windows operating system, or the Apple Corporation's macOS® operating system. The operating system may include, or interface with one or more virtual machine modules, such as, a Java virtual machine module that enables control of hardware components or operating system operations via Java application programs. Likewise, other runtime environments may be included.

Memory 304 may further include one or more data storage 310, which can be utilized by network computer 300 to store, among other things, applications 320 or other data. For example, data storage 310 may also be employed to store information that describes various capabilities of network computer 300. The information may then be provided to another device or computer based on any of a variety of methods, including being sent as part of a header during a communication, sent upon request, or the like. Data storage 310 may also be employed to store social networking information including address books, buddy lists, aliases, user profile information, or the like. Data storage 310 may further include program code, data, algorithms, and the like, for use by a processor, such as processor 302 to execute and perform actions such as those actions described below. In one embodiment, at least some of data storage 310 might also be stored on another component of network computer 300, including, but not limited to, non-transitory media inside processor-readable removable storage device 336, processor-readable stationary storage device 334, or any other computer-readable storage device within network computer 300, or even external to network computer 300. Data storage 310 may include, for example, data models 314, data sources 316, data catalogs 318, or the like.

Applications 320 may include computer executable instructions which, when executed by network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. Applications 320 may include data engine 322, other applications 329, or the like, that may be arranged to perform actions for embodiments described below. In one or more of the various embodiments, one or more of the applications may be implemented as modules or components of another application. Further, in one or more of the various embodiments, applications may be implemented as operating system extensions, modules, plugins, or the like.

Furthermore, in one or more of the various embodiments, data engine 322, other applications 329, or the like, may be operative in a cloud-based computing environment. In one or more of the various embodiments, these applications, and others, that comprise the management platform may be executing within virtual machines or virtual servers that may be managed in a cloud-based based computing environment. In one or more of the various embodiments, in this context the applications may flow from one physical network computer within the cloud-based environment to another depending on performance and scaling considerations automatically managed by the cloud computing environment. Likewise, in one or more of the various embodiments, virtual machines or virtual servers dedicated to data engine 322, other applications 329, or the like, may be provisioned and de-commissioned automatically.

Also, in one or more of the various embodiments, data engine 322, other applications 329, or the like, may be located in virtual servers running in a cloud-based computing environment rather than being tied to one or more specific physical network computers.

Further, network computer 300 may also comprise hardware security module (HSM) 360 for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, HSM 360 may be a stand-alone network computer, in other cases, HSM 360 may be arranged as a hardware card that may be installed in a network computer.

Additionally, in one or more embodiments (not shown in the figures), network computer 300 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the network computer may include one or more hardware microcontrollers instead of a CPU. In one or more embodiments, the one or more microcontrollers may directly execute their own embedded logic to perform actions and access their own internal memory and their own external Input and Output Interfaces (e.g., hardware pins or wireless transceivers) to perform actions, such as System On a Chip (SOC), or the like.

### Illustrative Logical System Architecture

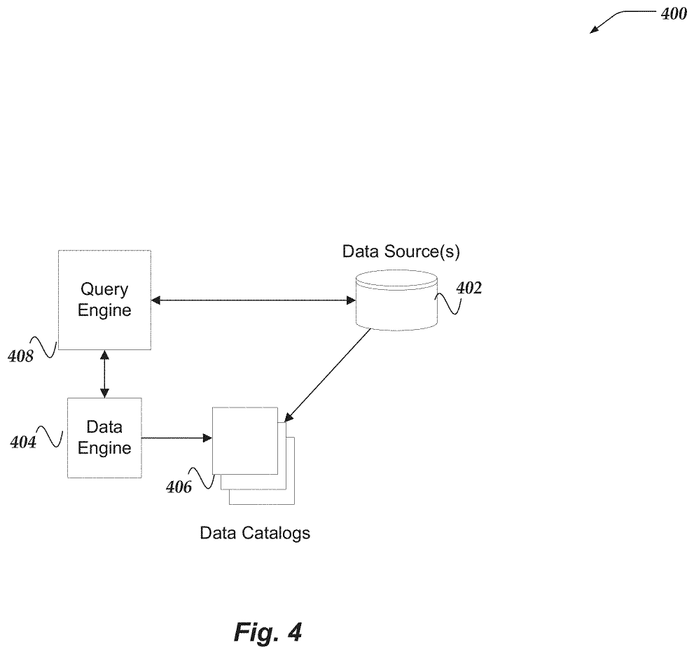

FIG. 4 illustrates a logical architecture of system 400 for conditional filters with applications to join processing in accordance with one or more of the various embodiments. In one or more of the various embodiments, system 400 may be arranged to include one or more data sources, such as, data source 402, one or more data engines, such as, data engine 404, one or more data catalogs, such as, data catalogs 406, one or more query engines, such as query engine 408, or the like.

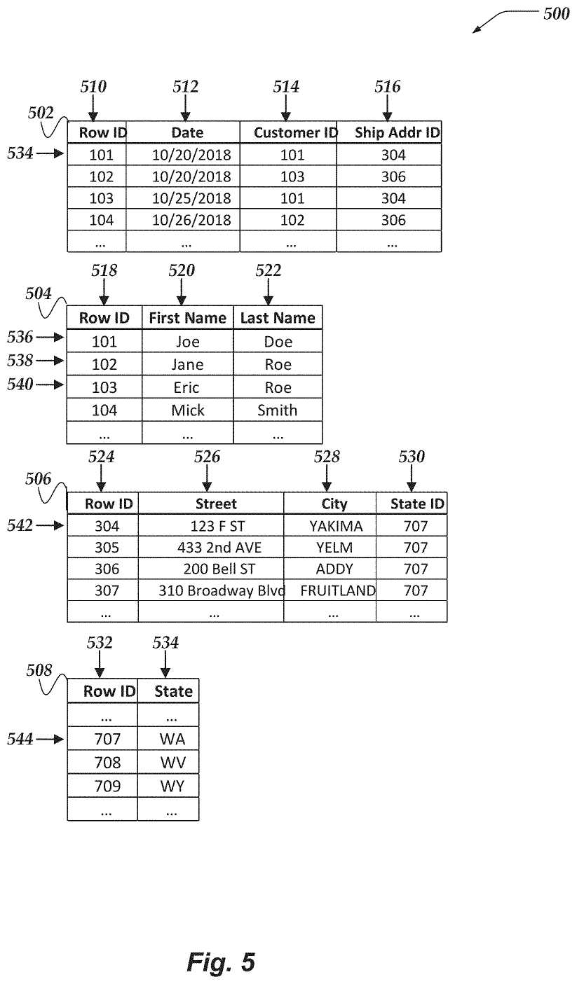

In one or more of the various embodiments, data source 402 may be arranged to store one or more data objects. In one or more of the various embodiments, data objects may be considered fact objects or attribute objects. In some embodiments, fact objects may be provided one or more attribute values from one or more attribute objects. See, FIG. 5 for a detailed example of data objects and attribute objects.

In one or more of the various embodiments, data source 402 may be a database, file system, repository, document management system, or the like.

In one or more of the various embodiments, data engine 404 may be arranged to generate one or more data catalogs based on the data objects stored in data source 402. Accordingly, in one or more of the various embodiments, data engines may be arranged to analyze one or more data objects that may be in data source 402 to generate one or more entries for data catalogs 406.

In one or more of the various embodiments, data engines may be arranged to selectively generate one or more data catalogs for one or more fact objects. In some embodiments, data engines may be arranged to generate one or more data catalogs off-line or otherwise in preparation for subsequent query activity. Also, in one or more of the various embodiments, data engines may be arranged to generate one or more data catalogs on-the-fly as they may be needed for responding to queries.

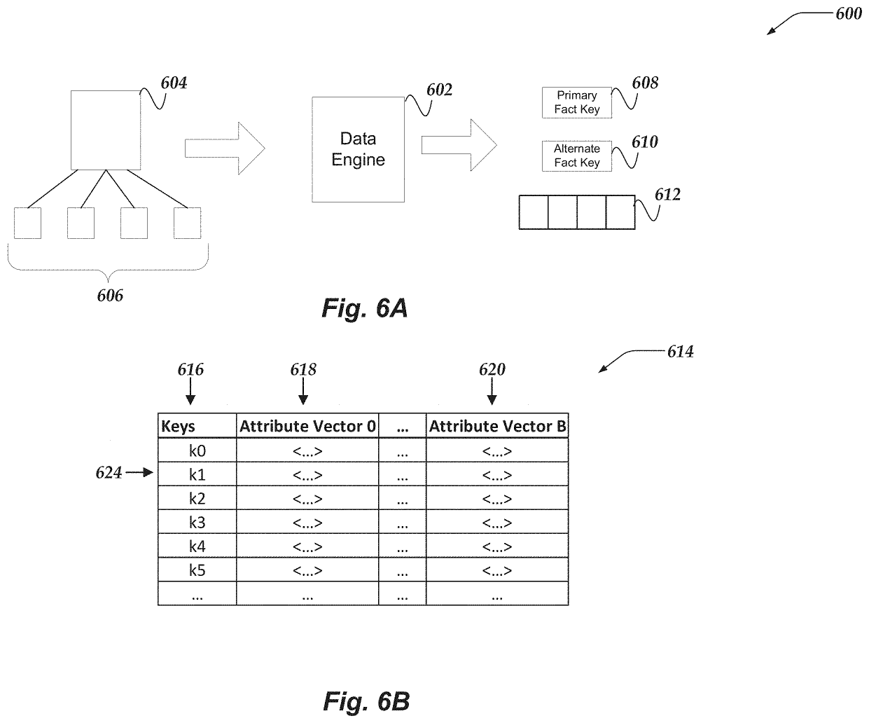

In one or more of the various embodiments, data catalogs may be arranged to include records that include fact keys and attribute fingerprint vectors (hereafter referred to as attribute vectors) that correspond to one or more fact object instances where different fact object instances may have different fact keys. In one or more of the various embodiments, data engines may be arranged to generate optimized values that may be employed as fact keys. See, FIGS. 6A and 6B for detailed descriptions of fact keys and attribute vectors. However, briefly, in some embodiments, fact keys may be mapped to one or more fact objects and the associated attribute vectors may be arranged to include attribute keys that map to identifiers for attribute objects that may be associated with fact objects.

Accordingly, in some embodiments, data catalogs may be considered data structures that are indexed by the fact keys and for each fact key there may be a corresponding attribute vector. In some embodiments, attribute vectors may be data structures that may be optimized to efficiently store attribute object information associated with a given fact object.

In one or more of the various embodiments, query engine 408 may be arranged to answer set membership queries, or the like. In some embodiments, query engine 408 may be considered to be part of a larger database engine or query planner designed for processing database table joins, another service or applications, or the like.

In one or more of the various embodiments, query engine 408 may be arranged to provide query information that includes identity information for one or more fact objects as well as identity information or values for one or more attribute objects that correspond to one or more attribute objects that may be associated with the fact objects.

In some embodiments, the data engine may be arranged to generate fact keys from the fact objects and one or more attribute keys from the query information. Thus, in some embodiments, the fact keys and attribute keys may be employed with one or more data catalogs to determine which fact objects may match the query based on whether an entry in the data catalog corresponds to the fact objects of interest.

For example, in one or more of the various embodiments, the query information may be based on a database query that may be joining a fact object table with one or more attribute object tables, such that, a result should include fact objects that have attributes that match the fact key and the one or more attribute keys generated from the query information. Accordingly, in this example, query engine 408 may be enabled to employ the data engine and data catalogs to determine whether to include one or more fact objects in a result set (or query plan) rather than having to scan the data source directly.

Likewise, for example, in some embodiments, data engine may be employed for testing white-list or black-list membership for network management applications, such as, firewalls. For example, a network connection may be considered a data object, such that some or all of the source network address information may be used to generate fact keys and one or more characteristics (e.g., port numbers, one or more TCP header fields, one or more HTTP header fields, or the like) may be considered to be attributes. Accordingly, in some embodiments, a data catalog arranged to be a white-list may be populated with fact keys that correspond to IP addresses, and attributes that correspond to allowed ports, cipher suites, user-agents, or the like.

Note, while database operations and network firewalls are presented herein as use cases, one of ordinary skill in the art will appreciate that set membership testing may be advantageous to many applications or problem domains. Accordingly, for brevity and clarity, the disclosure of these innovations will focus on set membership testing rather than the larger systems that may benefit from improved set membership testing performance.

FIG. 5 illustrates a logical schematic of a portion of system 500 for conditional filters with applications to join processing in accordance with one or more of the various embodiments. In one or more of the various embodiments, data sources may include one or more data objects, such as, tables, files, objects, classes, of the like. In one or more of the various embodiments, each data object may include one or more items each associated with one or more fields. Accordingly, in some embodiments, each item in a data object may represent an instance of an entity that may include values for some or all of the fields defined for the data object.

In this example, system 500 includes a portion of data objects that may be stored in one or more data sources. In this non-limiting example, the data source objects are represented as tables from a relational database (e.g., RDBMS). One of ordinary skill in the art will appreciate that production data sources may include many more data objects from databases (e.g., SQL databases, graph databases, no-sql databases, or the like), remote data providers, service APIs, remote streams, files, or the like. However, in this example, for brevity and clarity, four simple data objects are included. One of ordinary skill in the art will appreciate that this example is at least sufficient for disclosing the innovations included herein.

In one or more of the various embodiments, data sources may include one or more data objects, such as, table 502, table 504, table 506, table 508, or the like. In this example, table 502 may represent orders; table 504, may represent customers; table 506 may represent addresses; and table 508 may represent States.

In this example, for some embodiments, table 502 may include various fields associated with orders. Accordingly, in this example, field 510 may represent row identifiers for order records; field 512 may represent the date of an order; field 514, may represent a customer identifier that references a customer associated with an order; field 516, may represent an identifier that references an address where the order may be delivered; or the like.

In this example, for some embodiments, table 504 may include various fields associated with customers. Accordingly, in this example, field 518 may represent row identifiers for customer records; field 520 may represent a first name of a customer; field 522, may represent a last name of a customer; or the like.

In this example, for some embodiments, table 506 may include various fields associated with addresses. Accordingly, in this example, field 524 may represent row identifiers for address records; field 526 may represent a street portion of an address; field 528, may represent a city of an address; field 530 may represent a state identifier that references a state associated with an address; or the like.

Also, in this example, for some embodiments, table 508 may include various fields associated with states. Accordingly, in this example, field 532 may represent row identifiers for state records; field 534 may represent the abbreviation for states; or the like.

In one or more of the various embodiments, individual fields in data source objects, such as, table 502-508 may reference of fields in other data source objects. In this example, order table 502 includes two fields that reference other tables, namely, customer table 504 and address table 506. Accordingly, in one or more of the various embodiments, these references result in edge 554 and edge 556.

For example, order record 534 has a row (or record) identifier of 101, a reference to a customer associated with customer identifier having a value of 101, and a reference to an address associated with address identifier having a value of 304.

Accordingly, in this example, order record 101 is for customer 101 known as Joe Doe and should be shipped to address 542, which in this example is 123 F ST, YAKIMA. Note, the address record 542 includes a reference to state 707 which corresponds to WA in states table 508.

In some cases, for some embodiments, data objects may be described in part based on cardinality relationships between objects, such as, one-to-one, many-to-one, one-to-many, many-to-many, or the like.

In this example, the relationship between orders and customers may be considered many-to-one, because more than one order instance may be associated with the same customer. Likewise, in this example, the relationship between orders and addresses may be considered many-to-one, because more than one order may ship to the same address.

Accordingly, in this example, table 502 may be considered a fact object because it includes references to two attribute objects, namely customers in table 504 and shipping addresses stored in table 506. Also, in some cases, the same data object (or table) may be a fact object or an attribute object depending on the context of a given query. For example, table 506 defines a data object representing addresses but it includes a reference to table 508 that defines a data object that represent States. Accordingly, in some embodiments, address objects may be considered fact objects that are associated with an attribute object that represents the State.

FIG. 6A illustrates a logical schematic showing a portion of data processing system 600 for generating data catalogs for conditional filters with applications to join processing in accordance with one or more of the various embodiments. In one or more of the various embodiments, data engine 602 may be arranged process data objects from a data source to generate data catalogs.

In one or more of the various embodiments, data engine 602 may be arranged to be provided one or more data objects, such as, data object 604, data objects 606, or the like. In this example, data object 604 may be considered a fact object and data objects 606 may be considered attribute objects. In this example, the lines connecting data object 604 and data objects 606 may be considered to represent that data objects 606 may be attribute objects of data object 604. Accordingly, for brevity and clarity data object 604 may be referred to as fact object 604 and data objects 606 may be referred to as attribute objects 606.

In this example, for some embodiments, data engine 602 may be arranged to generate data catalog information based on fact object 604 and attribute objects 606. Accordingly, in some embodiments, data engine 602 may be arranged to generate data catalog information comprised of primary fact key 608, primary fact key 610, and attribute vector 612.

In one or more of the various embodiments, data engines may be arranged to generate fact keys from unique identifiers associated with fact objects. In some embodiments, fact keys may be generated based on one or more hash functions, or the like. Accordingly, in some embodiments, fact keys may be considered keys provided by a particular hash function. In some embodiments, the selection of the particular hash function may be based on one or more design requirements associated with a data catalog. For example, in some embodiments, it may be advantageous to select hash functions so the key size may be limited to a defined number of bits. In other embodiments, other characteristics may be considered, such as, speed of operation, availability of hardware acceleration, distribution characteristics of keys in the key space, or the like. Accordingly, in one or more of the various embodiments, data engines may be arranged to determine the specific hash function or hash facility to employ based on configuration information to account for local circumstances or local requirements.

In one or more of the various embodiments, primary fact keys and alternate fact keys may be generated for each fact object. In some embodiments, employing more than one key may provide some robustness to data catalogs with respect key collision. In some embodiments, it may be advantageous to minimize the memory footprint of data catalogs so fact keys may be restricted in size (e.g., bit length) which may increase the likelihood of hash key collisions where fact keys for two or more fact objects may have the same value. See, below for a more detailed discussion of this feature.

In one or more of the various embodiments, in addition to fact keys, data engines may be arranged to generate attribute vectors, such as, attribute vector 612. In some embodiments, attribute vectors may be arranged to store information that may be associated with the attribute objects associated with a particular fact object. Thus, in this example, attribute vector 612 may store information associated with attribute objects 606.

In one or more of the various embodiments, data engines may be arranged to generate attribute keys for one or more attribute objects that may be associated with a fact object. Accordingly, in some embodiments, the generated attribute keys may be stored in an attribute vector, such as, attribute vector 612. In this example, attribute objects 606 includes four objects so attribute vector 612 includes four attribute keys.

In one or more of the various embodiments, the format or contents that comprise an attribute key may vary depending various design or performance constraints. For example, in some embodiments, the number of attribute keys may be limited or fixed to specific value rather than being dynamically sized based on the number of attribute objects. Also, in some embodiments, each attribute key may be limited to a fixed size (e.g. bit size). For example, for some embodiments, it may be advantageous to limit the total size of an attribute vector to 64-bits with 4 bits reserved for meta-data or control information and 60 bits remaining for attribute keys. Accordingly, in this example, such constraints would allow 15 bits for each attribute key. One of ordinary skill in the art will appreciate that the specific determination of fact key size, attribute vector capacity, attribute key size, or the like, will vary depending on local constraints, such as, performance, cost, power considerations, physical size (e.g., chip size, device size, or the like), or the like. Accordingly, in some embodiments, data engines may be arranged to determine fact key size, attribute vector capacity, attribute key size, or the like, based on configuration information. In some embodiments, hardware limitations, such as, CPU word size, cache memory availability, or the like, may contribute to the determination of fact key size, attribute vector capacity, attribute key size, or the like.

FIG. 6B illustrates a logical schematics of data catalog 614 for conditional filters with applications to join processing in accordance with one or more of the various embodiments. In some embodiments, data catalogs, such as, data catalog 614 may be arranged include two or more columns, such as, column 616 for storing fact keys, column 618 for storing an attribute vector, column 620 for another attribute vector, or the like.

Accordingly, in this example, the values in column 616 may be considered fact keys represented here as k0, k1,. . . , k5. Likewise, in this example, the values in column 618 or column 620 may be considered to be attribute vectors that each store attribute keys for a fact object.

In some embodiments, data catalogs may be arranged to have more than one or more attribute vector columns. Accordingly, a data catalog record, such as, record 624 may include a fact key and one or more attribute vectors, each representing attribute objects for different fact objects that have the same valued fact key. In some embodiments, each location in a data catalog that may store an attribute vector for a different fact object may be considered a bucket. Accordingly, in some embodiments, if a data catalog may be associated four attribute vectors with one fact key, the data catalog may be considered to have a bucket size of four.

In some embodiments, data catalogs may be arranged to include additional columns for holding meta-data, or the like. Also, in some embodiments, data catalogs may be arranged to information from the fact object itself with some or all of the values associated with the fact object. For example, for some embodiments, if record 624 in data catalog 614 represents record 534 in FIG. 5, the value of column 512 for record 534 (date) may be stored in the data catalog as well. In such case, for some embodiments, the value information may be appended or prepended to attribute vectors.

In one or more of the various embodiments, data engines may be arranged to enable more attribute vectors for more than one fact object to be associated with the same fact key. For example, if fact keys generated for two or more different fact objects have the same value, data engines may be arranged to store each attribute vector in one of the buckets associated with the fact key.

However, in some embodiments, in some cases, all of the buckets for a given fact key may be in use. For example, in some embodiments, if data catalog 614 has a bucket size of four, attribute vectors for four different fact objects may be associated with the same fact key. Thus, in this example, if a fifth fact object is associated with the same fact key, there will be no room to store that fact object's attribute vector using a fact key that is already associated with four other fact objects.

Accordingly, in one or more of the various embodiments, if there is no room in the data catalog at particular fact key position (record), data engines may be arranged to employ the alternate fact key (e.g., alternate fact key 610) to determine where to insert the attribute vector associated with the fact object. Thus, in some embodiments, data engines may be arranged to first attempt to use primary fact keys to determine where to store fact object attribute vectors in a data catalog. And, if all the buckets in the data catalog at the position associated with the primary fact key are full, data engines may be arranged to use the alternate fact key to determine where to store the attribute vector in the data catalog.

In one or more of the various embodiments, if the location in a data catalog associated with an alternate fact key is also full, data engines may be arranged to attempt to move one of the attribute vectors to another position in data catalog based on the alternate fact key associated with the attribute vector that may be chosen to move. Note, for some embodiments, in some cases, a data catalog may reach full capacity, or close to it, such that it may take several move operations to find an available bucket in the data catalog. Accordingly, in one or more of the various embodiments, data engines may be arranged to enforce a limit on the number of bump attempts that may occur before alternative measure are taken, such as, raising errors, executing a spill-over/overflow policy, or the like.

In one or more of the various embodiments, data engines may be arranged to employ various spill-over/overflow strategies depending on design or performance requirements. In some embodiments, if more than one option for handling overflows may be available, data engines may be arranged to employ rules, conditions, or the like, provided via configuration information to account for local circumstances.

In one or more of the various embodiments, Bloom filters may be substituted for attribute vectors. Accordingly, in some embodiments, data engines may be arranged to represent attributes associated with fact objects using Bloom filters. In one or more of the various embodiments, each (attribute name, value) pair may be inserted into a small Bloom filter. The resulting sketch may simply be a data catalog with an added Bloom filter for each entry.

In one or more of the various embodiments, data engines may be arranged to dynamically convert one or more fact key locations in data catalogs to use Bloom filters. For example, in one or more of the various embodiments, if the utilization of a data catalog exceeds a defined threshold value, a data engine may be arranged to automatically convert one or more attribute vectors to Bloom filters. Also, in some embodiments, data engines may be arranged to increase the size of data catalog as needed.

### Generalized Operations

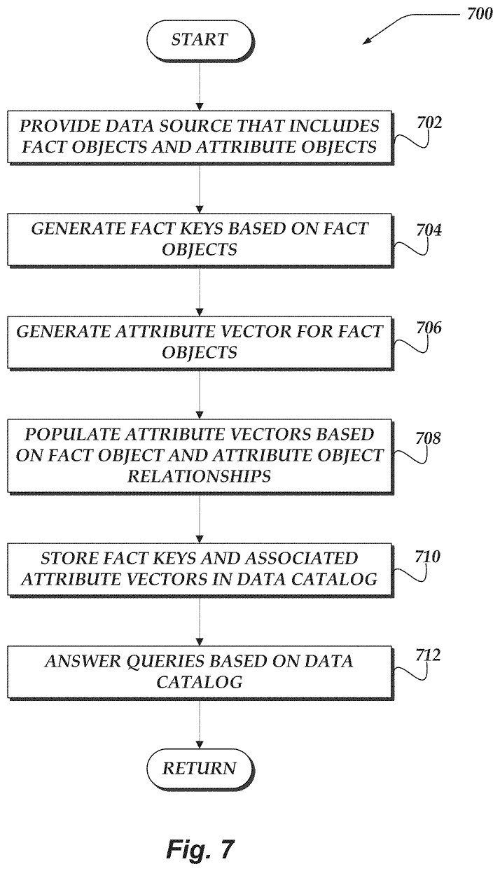

FIGS. 7-10 represent generalized operations for conditional filters with applications to join processing in accordance with one or more of the various embodiments. In one or more of the various embodiments, processes 700, 800, 900, and 1000 described in conjunction with FIGS. 7-10 may be implemented by or executed by one or more processors on a single network computer (or network monitoring computer), such as network computer 300 of FIG. 3. In other embodiments, these processes, or portions thereof, may be implemented by or executed on a plurality of network computers, such as network computer 300 of FIG. 3. In yet other embodiments, these processes, or portions thereof, may be implemented by or executed on one or more virtualized computers, such as, those in a cloud-based environment. However, embodiments are not so limited and various combinations of network computers, client computers, or the like may be utilized. Further, in one or more of the various embodiments, the processes described in conjunction with FIGS. 7-10 may be used for conditional filters with applications to join processing in accordance with at least one of the various embodiments or architectures such as those described in conjunction with FIGS. 4-6. Further, in one or more of the various embodiments, some or all of the actions performed by processes 700, 800, 900, and 1000 and may be executed in part by data engine 322, or the like.

FIG. 7 illustrates an overview flowchart for process 700 for conditional filters with applications to join processing in accordance with one or more of the various embodiments. After a start block, at block 702, in one or more of the various embodiments, one or more data sources that include one or more fact objects and one or more attribute objects may be provided to a data engine.

At block 704, in one or more of the various embodiments, the data engine may be arranged to generate one or more fact keys based on the one or more fact objects. In one or more of the various embodiments, fact keys may be generated from one or more fields or values associated with a fact object. In many cases, fact keys may be based on identifier fields (e.g., row ID) or values of fact objects. In one or more of the various embodiments, fact keys may be arranged to fit within various design requirements, such as, key-size, key space requirements, ease of generation, or the like. For example, for some embodiments, a data engine may be configured to receive a 32-bit identifier that may be reduced down to a 7-bit fact key by a hash function.

In one or more of the various embodiments, data engines may be arranged to generate a primary fact key and an alternate fact key. In some embodiments, the generation of alternate fact keys may be delayed until they may be actually needed.

At block 706, in one or more of the various embodiments, the data engine may be arranged to generate attribute vectors for the one or more fact objects. In one or more of the various embodiments, attribute vectors may be employed to associate fact object attributes with a fact key. In one or more of the various embodiments, the size of attribute vectors may vary depending on design considerations. In some embodiments, size constraints may restrict the size of attribute vectors, such that they have only have room for some attribute information rather than all attribute information associated with a fact object. As described above, in some embodiments, the particular size of an attribute vector may be determined based on configuration information to account for local requirements or local circumstances.

At block 708, in one or more of the various embodiments, the data engine may be arranged to populate the attribute vectors with attribute keys based on the associations or relationships between the fact objects and the attribute objects. As described above, attribute objects are usually associated with fact objects based on identifiers stored with the fact object. In some embodiments, fact objects may include a reference that identifies a particular instance of an attribute object. For example, referring to record 534 in FIG. 5, Order objects (table 502) include references to customers and shipping addresses. Accordingly, in one or more of the various embodiments, attribute keys generated for record 534 may reflect that for record 534, “customer-id=101” and “shipaddr-id=304” may be employed to generate attribute keys while attribute keys for the order with “Row ID=102” (the record located immediately below record 534) may be based on “customer-id=103” and “shipaddr-id=306”

Similar to the generation of fact keys from fact object identifiers, data engines may be arranged to employ a function or formula (e.g., hash functions) to generate attribute keys from attribute fields included in a fact object. In some embodiments, the entire attribute field and values may be included in the attribute vector. In other embodiments, attribute keys may be based on the value of an attribute field. Also, in some embodiments, data engines may be arranged to determine attribute key characteristics, such as, bit-size, key space characteristics, or the like, based on configuration information to account for local circumstances or local requirements.

At block 710, in one or more of the various embodiments, the data engine may be arranged to store the fact keys and the associated attribute vectors in a data catalog. As described above, fact keys and attribute vectors may be stored in a data catalog data structure. In some embodiments, it may be advantageous for a data catalog to remain in RAM rather than being pushed onto disk storage. Accordingly, in one or more of the various embodiments, data engines may be arranged to determine some or all of the data catalog data structure parameters or characteristics from configuration information to account for local circumstances that may be tailored to avoid storing data catalogs (or portions thereof) on disk storage.

At block 712, in one or more of the various embodiments, a query engine may be arranged to employ the data catalog to process queries. In one or more of the various embodiments, data catalogs may be employed to provide rapid set membership testing in support of various query operations, such as, joins, or the like. In some cases, queries may be set membership questions that may be answered directly using data catalogs. In other embodiments, the answers provided by data catalog (e.g., set membership, set non-membership, or the like) may be provided to improve the performance of query planners executing more complex queries.

Next, in one or more of the various embodiments, control may be returned to a calling process.

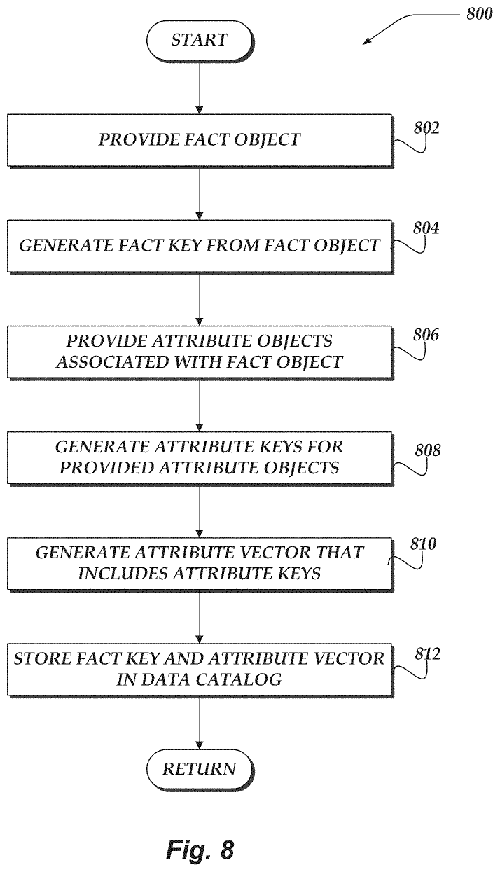

FIG. 8 illustrates a flowchart for process 800 for processing a fact object for conditional filters with applications to join processing in accordance with one or more of the various embodiments. After a start block, at block 802, in one or more of the various embodiments, a fact object instance may be provided to a data engine.

At block 804, in one or more of the various embodiments, the data engine may be arranged to generate a fact key based on the fact object. As described above, the data engine may be arranged to generate fact keys based on an identifier of the fact object.

At block 806, in one or more of the various embodiments, one or more attribute objects associated with the fact object may be provided. In one or more of the various embodiments, fact objects may include one or more fields that are designed to reference attribute objects. In some embodiments, such fields may be explicitly identified by the data source (tagged as foreign keys). In other embodiments, the data engine or other processes may be enabled to infer if a field in a fact object includes a reference to an attribute object. In either case, it may be assumed that the attribute objects for provided fact objects have been identified. For example, in some embodiments, the data engine may be provided query information that includes information that may be employed to determine one or more fields, one or more properties, or one or more attributes of the fact object.

In some embodiments, the data engine may obtain the necessary attribute object information directly from the fact objects. For example, if the fact object includes attribute references/identifiers in a field, in some embodiments, the data engine may rely on those attribute object references rather than being provided the attribute objects. Though, in some embodiments, data engines may be arranged to perform additional validation, or the like, that may require examination of the attribute object rather than just relying on the attribute object identifiers included in fact object instances.

At block 808, in one or more of the various embodiments, the data engine may be arranged to generate attribute keys for the provided attribute objects.

In one or more of the various embodiments, data engines may be arranged to employ rules, instruction, templates, or the like, provided by configuration information to determine how to generate attribute keys from attribute objects. Accordingly, in one or more of the various embodiments, various characteristics of attribute keys may vary depending on design considerations or local circumstances. In some embodiments, data engines may be arranged to employ a hash function to generate attribute keys that fit the size or key space requirements for a particular organization.

At block 810, in one or more of the various embodiments, the data engine may be arranged to generate an attribute vector that includes the generated attribute keys. In one or more of the various embodiments, the size of the attribute vector may vary depending on the number of attribute keys. In some embodiments, the number of attribute keys may be limited such that some attributes may be excluded. In some embodiments, data engines may be arranged to determine the size or capacity of attribute vectors based on configuration information to account for local conditions or circumstances.

At block 812, in one or more of the various embodiments, the data engine may be arranged to store the fact key and attribute vector in the data catalog. As described herein, the attribute vectors may be stored and associated with the fact key. In some embodiments, there may be no room for the fact key and attribute vector, if so, the data engine may employ an alternate fact key or initiate shifting operations to attempt to make find room to store the fact key and attribute vector. In one or more of the various embodiments, data engines may be arranged manage facts keys or alternate fact keys using Cuckoo filters, Cuckoo filter semantics, or portion thereof.

Next, in one or more of the various embodiments, control may be returned to a calling process.

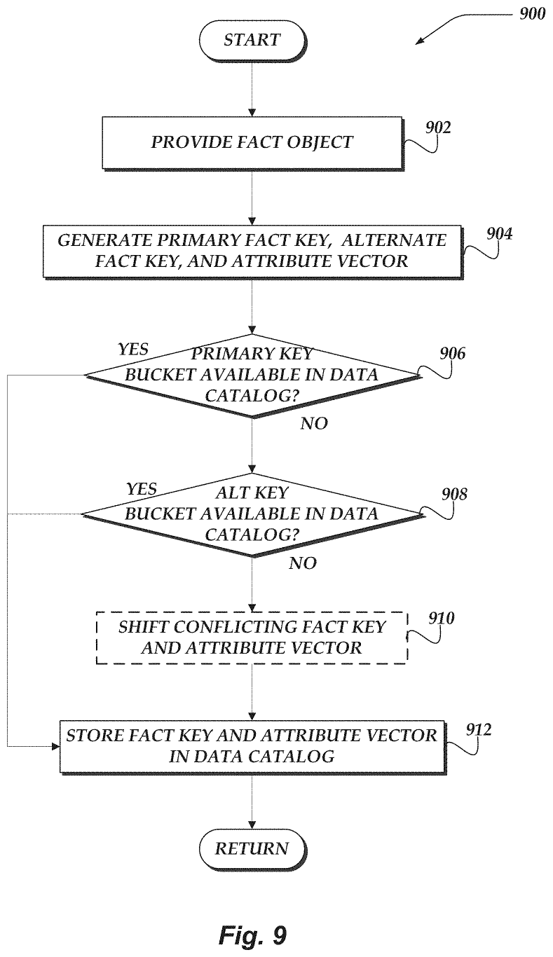

FIG. 9 illustrates a flowchart for process 900 for inserting a fact information into a data catalog in accordance with one or more of the various embodiments. After a start block, at block 902, in one or more of the various embodiments, a fact object may be provided to a data engine.

At block 904, in one or more of the various embodiments, the data engine may be arranged to generate a primary fact key, alternate fact key, and an attribute vector for the fact object. As described above, data catalogs may be similar to hash tables in that the fact keys may be subject to key collision and each key entry in a data catalog may have a limited number of buckets. Accordingly, in some embodiments, if there is no room in the data catalog to store the attribute vector using the primary fact key, the alternate fact key may be employed to determine a location in the data catalog for storing the attribute vector.

At decision block 906, in one or more of the various embodiments, if a primary fact key bucket is available in the data catalog, control may flow to block 912; otherwise, control may flow to decision block 908. In one or more of the various embodiments, if the data engine determines that the primary fact key is already in the data catalog and the buckets for that key position are filled, the attribute vector cannot be stored using the primary fact key. Alternatively, in some embodiments, if the primary fact key is not in the data catalog, the primary fact key and the attribute vector may be stored. Or, in some embodiments, if the primary fact key is in the data catalog and there is an available bucket, the attribute vector may be stored in the data catalog at one of the available bucket locations.

At decision block 908, in one or more of the various embodiments, if an alternate fact key bucket may be available in the data catalog, control may flow to block 912; otherwise, control may flow to block 910. As described above, data engines may be arranged to employ the alternate fact key if there is no room in the data catalog to store the attributed vector using the primary fact key.

At block 910, in one or more of the various embodiments, optionally, the data engine may be arranged to shift the conflicting attribute vector to another position in the data catalog based on the primary fact key or alternate fact key that may be associated with the attribute vector being moved.

Note, this block is marked optional because, in some embodiments, shifting is not always required. Also, in some embodiments, it may require more than one shift operation to adjust the data catalog records to accommodate the insertion of a new attribute vector. Accordingly, in some embodiments, data engines may be arranged to enforce a limit on the number of shift attempts before trying a different strategy to accommodate the insertion of the new attribute vector.

At block 912, in one or more of the various embodiments, the data engine may store the attribute vector and the fact key value, if needed. In some embodiments, the fact key may be present in the data catalog. Accordingly, the attribute vector may be stored at location in the data catalog the corresponds to the fact key value.

Next, in one or more of the various embodiments, control may be returned to a calling process.

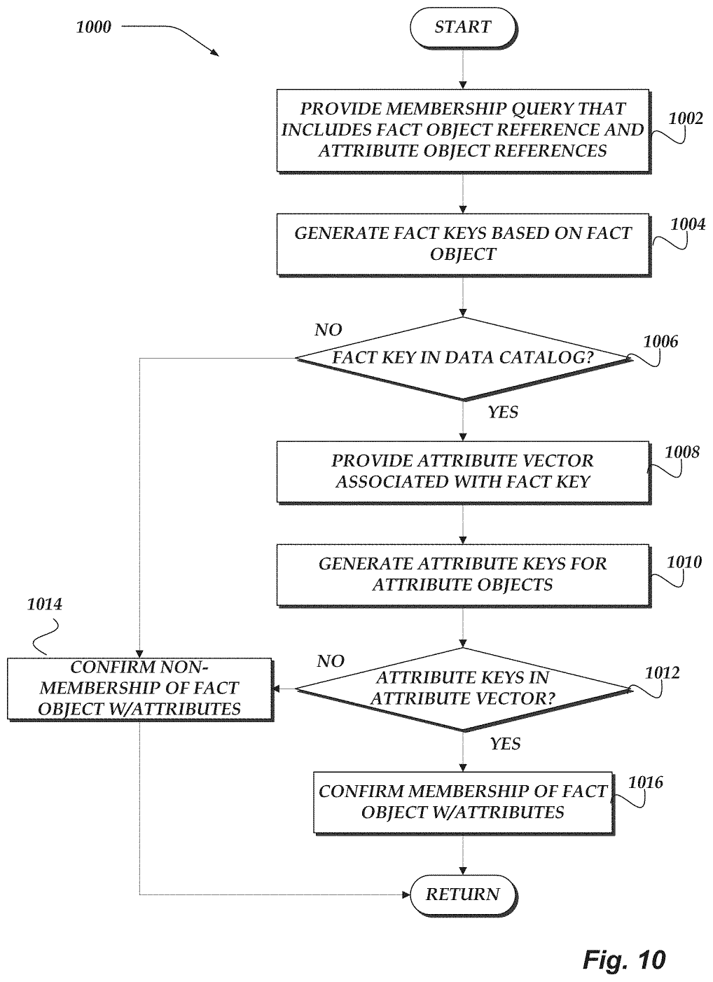

FIG. 10 illustrates a flowchart for process 1000 for responding to queries using data catalogs in accordance with one or more of the various embodiments. After a start block, at block 1002, in one or more of the various embodiments, a membership query may be provided to a data engine. In one or more of the various embodiments, the membership query may include one or more fact object references and one or more attribute object references. For example, a membership query may include information such as “order-id=100 with customer-id=101” where the order-id is the identifier of the fact object that the fact key is based on. And, in this example, customer-id is an attribute object identifier that may be included in the attribute vector.

At block 1004, in one or more of the various embodiments, the data engine may be arranged to generate fact keys for the fact object. In some embodiments, data engines may employ the same or similar method that was used to generate fact keys used populate the data catalog. Accordingly, in some embodiments, if a fact object identifier provided by the query has the same value as a fact object identifier used to populate the data catalog, the fact key of the provided fact object identifier will match the fact key value generated to populate the data catalog. For example, data engines may be arranged to employ the same hashing function for populating data catalogs as it employs for processing query information. Thus, in some embodiments, the data engine may generate a fact key from the query information. This fact key may be employed to determine if a fact object is included in a data catalog.

Accordingly, in some embodiments, the data engine may generate a primary fact key and an alternate fact key for the fact object referenced in the query information.

At decision block 1006, in one or more of the various embodiments, if the primary fact key may be found in the data catalog, control may flow to block 1008; otherwise, control may flow to block 1014.

At block 1008, in one or more of the various embodiments, the data engine may provide the attribute vector associated with the fact key.

At block 1010, in one or more of the various embodiments, the data engine may generate attribute keys for one or more or the attribute objects. In one or more of the various embodiments, data engines may be arranged to employ the same method for generating attribute keys as were used when populating the data catalog.

At decision block 1012, in one or more of the various embodiments, if the attribute keys may be found in the attribute vector, control may flow block 1016; otherwise, control may flow to block 1014. In one or more of the various embodiments, data engines may be arranged to examine the attribute vector to determine if the attribute keys based on the attribute objects included in the query information are present.

At block 1014, in one or more of the various embodiments, the data engine may be arranged to provide a confirmation to a caller that the fact object associated with the provided attribute objects is not included in the data catalog.

Next, in one or more of the various embodiments, control may be returned to a calling process.

At block 1016, in one or more of the various embodiments, the data engine may be arranged to provide confirmation that a fact object associated with the provided attribute objects is included in the data catalog.

Next, in one or more of the various embodiments, control may be returned to a calling process.

It will be understood that each block in each flowchart illustration, and combinations of blocks in each flowchart illustration, can be implemented by computer program instructions. These program instructions may be provided to a processor to produce a machine, such that the instructions, which execute on the processor, create means for implementing the actions specified in each flowchart block or blocks. The computer program instructions may be executed by a processor to cause a series of operational steps to be performed by the processor to produce a computer-implemented process such that the instructions, which execute on the processor, provide steps for implementing the actions specified in each flowchart block or blocks. The computer program instructions may also cause at least some of the operational steps shown in the blocks of each flowchart to be performed in parallel. Moreover, some of the steps may also be performed across more than one processor, such as might arise in a multi-processor computer system. In addition, one or more blocks or combinations of blocks in each flowchart illustration may also be performed concurrently with other blocks or combinations of blocks, or even in a different sequence than illustrated without departing from the scope or spirit of the invention.

Accordingly, each block in each flowchart illustration supports combinations of means for performing the specified actions, combinations of steps for performing the specified actions and program instruction means for performing the specified actions. It will also be understood that each block in each flowchart illustration, and combinations of blocks in each flowchart illustration, can be implemented by special purpose hardware-based systems, which perform the specified actions or steps, or combinations of special purpose hardware and computer instructions. The foregoing example should not be construed as limiting or exhaustive, but rather, an illustrative use case to show an implementation of at least one of the various embodiments of the invention.

Further, in one or more embodiments (not shown in the figures), the logic in the illustrative flowcharts may be executed using an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. In one or more embodiments, a microcontroller may be arranged to directly execute its own embedded logic to perform actions and access its own internal memory and its own external Input and Output Interfaces (e.g., hardware pins or wireless transceivers) to perform actions, such as System On a Chip (SOC), or the like.

What is claimed as new and desired to be protected by Letters Patent of the United States is:

1. A method for data processing using one or more network computers, comprising:
providing a plurality of fact objects and a plurality of attribute objects, wherein each of the attribute objects is associated with one or more fact objects;
generating a fact key for each of the plurality of fact objects based on information associated with each fact object;
determining one or more attribute objects associated with each of the plurality of fact objects based on attribute information associated with each fact object;
generating an attribute key for each of the one or more attribute objects based on the attribute information;
storing the one or more attribute keys and a plurality of fact keys at a plurality of storage locations in a data catalog, wherein each storage location corresponds to one of the plurality of fact keys; and
in response to a query that includes a query fact object and one or more query attribute objects, perform further actions, including:
generating a query fact key based on the query fact object;
generating one or more query attribute keys based on the one or more query attribute objects; and
providing a query result based on a comparison of the one or more query attribute keys and one or more attribute keys associated with another fact key in the data catalog having an equivalent value to the query fact key, wherein the query result is affirmative when the one or more query attribute keys match the one or more attribute keys associated with the other fact key.

2. The method of claim 1, further comprising:
generating an alternate fact key for each of the plurality of fact objects based on information associated with each fact object; and
in response to a location in the data catalog corresponding to the fact key being unavailable, storing the one or more attribute keys and the alternate fact key for each fact object at a storage location in the data catalog, wherein the storage location corresponds to the alternate fact key.

3. The method of claim 1, further comprising:
generating an attribute vector for a fact object stored at a storage location in the data catalog based on a number of the one or more attribute objects associated with the fact object;
storing the one or more attribute keys in the attribute vector; and
storing the attribute vector at the storage location.

4. The method of claim 1, further comprising:
generating a Bloom filter for one or more fact objects based on the one or more attribute keys;
storing the Bloom filter at each storage location in the data catalog associated with the one or more fact objects; and
employing the Bloom filter to determine when the query attribute keys have equivalent values to the one or more attribute keys associated with the other fact key.

5. The method of claim 1, further comprising, generating the data catalog based on a cuckoo filter, wherein each cuckoo filter key is a fact key or an alternate fact key associated with a fact object.

6. A processor readable non-transitory storage media that includes instructions for data processing, wherein execution of the instructions by one or more processors, performs actions, comprising:
providing a plurality of fact objects and a plurality of attribute objects, wherein each of the attribute objects is associated with one or more fact objects;
generating a fact key for each of the plurality of fact objects based on information associated with each fact object;
determining one or more attribute objects associated with each of the plurality of fact objects based on attribute information associated with each fact object;
generating an attribute key for each of the one or more attribute objects based on the attribute information;
storing the one or more attribute keys and a plurality of fact keys at a plurality of storage locations in a data catalog, wherein each storage location corresponds to one of the plurality of fact keys; and
in response to a query that includes a query fact object and one or more query attribute objects, perform further actions, including:
generating a query fact key based on the query fact object;
generating one or more query attribute keys based on the one or more query attribute objects; and
providing a query result based on a comparison of the one or more query attribute keys and one or more attribute keys associated with another fact key in the data catalog having an equivalent value to the query fact key, wherein the query result is affirmative when the one or more query attribute keys match the one or more attribute keys associated with the other fact key.

7. The media of claim 6, further comprising:
generating an alternate fact key for each of the plurality of fact objects based on information associated with each fact object; and
in response to a location in the data catalog corresponding to the fact key being unavailable, storing the one or more attribute keys and the alternate fact key for each fact object at a storage location in the data catalog, wherein the storage location corresponds to the alternate fact key.

8. The media of claim 6, further comprising:
generating an attribute vector for a fact object stored at a storage location in the data catalog based on a number of the one or more attribute objects associated with the fact object;
storing the one or more attribute keys in the attribute vector; and
storing the attribute vector at the storage location.

9. The media of claim 6, further comprising:
generating a Bloom filter for one or more fact objects based on the one or more attribute keys;
storing the Bloom filter at each storage location in the data catalog associated with the one or more fact objects; and
employing the Bloom filter to determine when the query attribute keys have equivalent values to the one or more attribute keys associated with the other fact key.

10. The media of claim 6, further comprising, generating the data catalog based on a cuckoo filter, wherein each cuckoo filter key is a fact key or an alternate fact key associated with a fact object.

11. A system for data processing:
a network computer, comprising:
a transceiver that communicates over the network;
a memory that stores at least instructions; and
one or more processors that execute instructions that perform actions, including:
providing a plurality of fact objects and a plurality of attribute objects, wherein each of the attribute objects is associated with one or more fact objects;
generating a fact key for each of the plurality of fact objects based on information associated with each fact object;
determining one or more attribute objects associated with each of the plurality of fact objects based on attribute information associated with each fact object;
generating an attribute key for each of the one or more attribute objects based on the attribute information;
storing the one or more attribute keys and a plurality of fact keys at a plurality of storage locations in a data catalog, wherein each storage location corresponds to one of the plurality of fact keys; and
in response to a query that includes a query fact object and one or more query attribute objects, perform further actions, including:
generating a query fact key based on the query fact object;
generating one or more query attribute keys based on the one or more query attribute objects; and
providing a query result based on a comparison of the one or more query attribute keys and one or more attribute keys associated with another fact key in the data catalog having an equivalent value to the query fact key, wherein the query result is affirmative when the one or more query attribute keys match the one or more attribute keys associated with the other fact key; and
a client computer, comprising:
a transceiver that communicates over the network;
a memory that stores at least instructions; and
one or more processors that execute instructions that perform actions, including:
providing the query.

12. The system of claim 11, wherein the one or more processors of the network computer execute instructions that perform actions, further comprising:
generating an alternate fact key for each of the plurality of fact objects based on information associated with each fact object; and
in response to a location in the data catalog corresponding to the fact key being unavailable, storing the one or more attribute keys and the alternate fact key for each fact object at a storage location in the data catalog, wherein the storage location corresponds to the alternate fact key.

13. The system of claim 11, wherein the one or more processors of the network computer execute instructions that perform actions, further comprising:
generating an attribute vector for a fact object stored at a storage location in the data catalog based on a number of the one or more attribute objects associated with the fact object;
storing the one or more attribute keys in the attribute vector; and
storing the attribute vector at the storage location.

14. The system of claim 11, wherein the one or more processors of the network computer execute instructions that perform actions, further comprising:
generating a Bloom filter for one or more fact objects based on the one or more attribute keys;
storing the Bloom filter at each storage location in the data catalog associated with the one or more fact objects; and
employing the Bloom filter to determine when the query attribute keys have equivalent values to the one or more attribute keys associated with the other fact key.

15. The system of claim 11, wherein the one or more processors of the network computer execute instructions that perform actions, further comprising, generating the data catalog based on a cuckoo filter, wherein each cuckoo filter key is a fact key or an alternate fact key associated with a fact object.

16. A network computer for data processing, comprising:
a transceiver that communicates over the network;
a memory that stores at least instructions; and
one or more processors that execute instructions that perform actions, including:
providing a plurality of fact objects and a plurality of attribute objects, wherein each of the attribute objects is associated with one or more fact objects;
generating a fact key for each of the plurality of fact objects based on information associated with each fact object;
determining one or more attribute objects associated with each of the plurality of fact objects based on attribute information associated with each fact object;
generating an attribute key for each of the one or more attribute objects based on the attribute information;
storing the one or more attribute keys and a plurality of fact keys at a plurality of storage locations in a data catalog, wherein each storage location corresponds to one of the plurality of fact keys; and
in response to a query that includes a query fact object and one or more query attribute objects, perform further actions, including:
generating a query fact key based on the query fact object;
generating one or more query attribute keys based on the one or more query attribute objects; and
providing a query result based on a comparison of the one or more query attribute keys and one or more attribute keys associated with another fact key in the data catalog having an equivalent value to the query fact key, wherein the query result is affirmative when the one or more query attribute keys match the one or more attribute keys associated with the other fact key.

17. The network computer of claim 16, further comprising:
generating an alternate fact key for each of the plurality of fact objects based on information associated with each fact object; and
in response to a location in the data catalog corresponding to the fact key being unavailable, storing the one or more attribute keys and the alternate fact key for each fact object at a storage location in the data catalog, wherein the storage location corresponds to the alternate fact key.

18. The network computer of claim 16, further comprising:
generating an attribute vector for a fact object stored at a storage location in the data catalog based on a number of the one or more attribute objects associated with the fact object;
storing the one or more attribute keys in the attribute vector; and
storing the attribute vector at the storage location.

19. The network computer of claim 16, further comprising:
generating a Bloom filter for one or more fact objects based on the one or more attribute keys;
storing the Bloom filter at each storage location in the data catalog associated with the one or more fact objects; and
employing the Bloom filter to determine when the query attribute keys have equivalent values to the one or more attribute keys associated with the other fact key.

20. The network computer of claim 16, further comprising, generating the data catalog based on a cuckoo filter, wherein each cuckoo filter key is a fact key or an alternate fact key associated with a fact object.
